(19) United States
(12) Patent Application Publication
(10) Pub. No.: US 2024/0126266 A1
(43) Pub. Date: Apr. 18, 2024

(54) TRAVEL CONTROL DEVICE FOR MOBILITY DEVICE AND METHOD FOR MOBILITY DEVICE

(71) Applicants: Hyundai Motor Company, Seoul (KR); Kia Corporation, Seoul (KR); MOBINN INC., Suwon-si (KR)

(72) Inventors: Sun Myoung JO, Ansan-si (KR); Jin CHOI, Seoul (KR); Hoon CHUNG, Hwaseong-si (KR)

(21) Appl. No.: 18/192,339

(22) Filed: Mar. 29, 2023

(30) Foreign Application Priority Data
Oct. 17, 2022 (KR) 10-2022-0133296

(51) Int. Cl. G05D 1/02; G01S 7/481; G01S 17/08

(52) U.S. Cl. CPC G05D 1/0223; G01S 7/4811; G01S 17/08

(57) ABSTRACT

A travel control device and method control for a mobility device is disclosed. The travel control device includes a distance sensor on one side frame of the mobility device and adjusts a travel speed of the mobility device based on a distance to stairs measured by the distance sensor when the mobility device travels on the stairs to reduce collision force between the mobility device and the stairs, thereby improving the traveling stability and immediacy of the mobility device.

### CROSS-REFERENCE TO RELATED APPLICATION

This application claims the benefit of priority to Korean Patent Application No. 10-2022-0133296, filed in the Korean Intellectual Property Office, on Oct. 17, 2022, the entire contents of which are incorporated herein by reference.

### TECHNICAL FIELD

The present disclosure relates to a technique for improving the speed and stability of an autonomous mobility device when traveling on stairs.

### BACKGROUND

Robot industries relate to a mobile robot (a mobility device). Interest in mobile robots is increasing in various industries such as logistics, manufacturing, distribution, and services. For example, many mobile robots may be used in logistics center, and mobile robots may perform tasks such as food delivery and product delivery. In addition, mobile robots may be used in various other fields.

For example, mobile robots distributed in medical institutions can serve to move patients and deliver supplies, such as medicines, to places where they are needed. The mobile robots may help in the surgical process and perform sterilization while moving from room to room. As another example, mobile robots distributed in workplaces (hotels, stores, etc.) may deliver convenience goods to room guests on behalf of hotel staff, or carry customers' purchases while autonomously moving within the store.

Although these mobile robots have the ability to move on flat ground as well as on stairs in the process of performing tasks, the reality is that speed and stability are weak when going up or down stairs.

Therefore, there is a need for a method to improve the speed and stability of the mobile robot when running on the stairs.

### SUMMARY

An aspect of the present disclosure provides a travel control device which includes a distance sensor on one side (e.g., rear wheel side) frame of the mobility device and adjusts a travel speed of the mobility device based on a distance to stairs measured by the distance sensor when the mobility device travels on the stairs to reduce collision force between the mobility device and the stairs, thereby improving the traveling stability and immediacy of the mobility device.

According to one aspect of the present disclosure, a travel control device for a mobility device includes a distance sensor mounted on one side frame of the mobility device and a controller that adjusts a travel speed of the mobility device based on a distance to stairs measured by the distance sensor when the mobility device travels on the stairs.

Implementations according to this aspect can include one or more of the following features. For example, the distance sensor can include a first laser sensor that measures a distance to uphill stairs when the mobility device travels forward on the uphill stairs and a second laser sensor that measures a distance to downhill stairs when the mobility device travels in reverse on the downhill stairs.

In some implementations, the controller can activate the first laser sensor when the mobility device travels forward on the uphill stairs.

In some implementations, the controller can activate the second laser sensor when the mobility device travels in reverse on the downhill stairs.

In some implementations, the controller can reduce the travel speed of the mobility device when the distance to the stairs is shorter than a first threshold distance when the mobility device travels forward on the uphill stairs.

In some implementations, the controller can reduce the travel speed of the mobility device when the distance to the stairs is longer than a second threshold distance when the mobility device travels in reverse on the downhill stairs.

In some implementations, the travel control device can further include a tilt sensor that measures a tilt of the mobility device, and the controller can adjust the travel speed of the mobility device when a tilt measured by the tilt sensor is greater than a threshold angle.

In some implementations, the distance sensor can include a laser sensor that measures a distance to stairs when the mobility device travels on the stairs, and a step motor that adjusts an irradiation direction of the laser sensor.

In some implementations, the controller can control the step motor such that the laser sensor has a first irradiation angle when the mobility device travels forward on uphill stairs and control the step motor such that the laser sensor has a second irradiation angle when the mobility device travels in reverse on downhill stairs.

In some implementations, the controller can reduce the travel speed of the mobility device when the distance to the stairs is shorter than a first threshold distance when the mobility device travels forward on uphill stairs.

In some implementations, the controller can reduce the travel speed of the mobility device when the distance to the stairs is longer than a second threshold distance when the mobility device travels in reverse on downhill stairs.

According to an aspect of the present disclosure, a travel control method for a mobility device includes activating, by a controller, a distance sensor mounted on one side frame of the mobility device when the mobility device travels on stairs, and adjusting, by the controller, a travel speed of the mobility device based on a distance to stairs measured by the distance sensor when the mobility device travels on the stairs.

In some implementations, the activating of the distance sensor can include activating, by the controller, the first laser sensor when the mobility device travels forward on the uphill stairs and activating, by the controller, the second laser sensor when the mobility device travels in reverse on the downhill stairs.

The adjusting of the travel speed of the mobility device can include reducing the travel speed of the mobility device when the distance to the stairs is shorter than a first threshold distance when the mobility device travels forward on the uphill stairs, and reducing the travel speed of the mobility device when the distance to the stairs is longer than a second threshold distance when the mobility device travels in reverse on the downhill stairs.

In some implementations, wherein the adjusting of the travel speed of the mobility device can include measuring, by a tilt sensor, a tilt of the mobility device and adjusting, by the controller, the travel speed of the mobility device based on a distance to stairs measured by the distance sensor when the tilt measured by the tilt sensor is greater than a threshold angle.

In some implementations, the activating of the distance sensor can include controlling the step motor such that the laser sensor has a first irradiation angle when the mobility device travels forward on uphill stairs, and controlling the step motor such that the laser sensor has a second irradiation angle when the mobility device travels in reverse on downhill stairs.

In some implementations, the adjusting of the travel speed of the mobility device can include reducing the travel speed of the mobility device when the distance to the stairs is shorter than a first threshold distance when the mobility device travels forward on uphill stairs.

In some implementations, the adjusting of the travel speed of the mobility device can include reducing the travel speed of the mobility device when the distance to the stairs is longer than a second threshold distance when the mobility device travels in reverse on downhill stairs.

### BRIEF DESCRIPTION OF THE DRAWINGS

The above and other objects, features and advantages of the present disclosure will be more apparent from the following detailed description taken in conjunction with the accompanying drawings.

FIG. 1 is a structural diagram of an example of a mobility device.

FIG. 2 is a view showing an example of an irradiation direction of a first laser sensor mounted on the mobility device.

FIG. 3 is a view showing an example of an irradiation direction of a second laser sensor mounted on the mobility device.

FIG. 4 is a view showing an example of the mobility device traveling on the flat ground.

FIG. 5 is a diagram showing an example of the mobility device traveling on uphill stairs.

FIG. 6 is a diagram showing an example of the mobility device traveling on downhill stairs.

FIG. 7 is a configuration diagram of a travel control device for a mobility device.

FIG. 8 is a view illustrating an example process of a controller, provided in a travel control device for a mobility device, to adjust a travel speed of the mobility device when traveling on uphill stairs.

FIG. 9 is a view illustrating an example process of a controller, provided in a travel control device for a mobility device, to adjust a travel speed of the mobility device when traveling on downhill stairs.

FIG. 10 is a configuration diagram showing an example of a travel control device for a mobility device.

FIG. 11 is a view illustrating an example of an irradiation angle of a laser sensor of the travel control device of FIG. 10.

FIG. 12 is a flowchart of an example of a travel control method for a mobility device.

FIG. 13 is a block diagram illustrating an example of a computing system for performing a method for controlling a travel control method for a mobility device.

### DETAILED DESCRIPTION

Hereinafter, one or more implementations of the present disclosure will be described in detail with reference to the exemplary drawings.

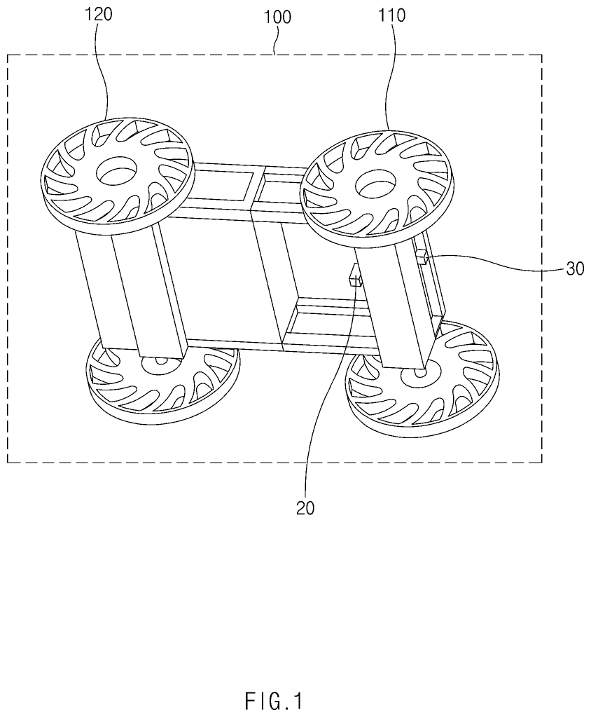

FIG. 1 is a structural diagram showing an example of a mobility device.

In some implementations, referring to FIG. 1, a mobility device 100 has four wheels and can include two rear wheels 110 and two front wheels 120. In some implementations, the mobility device 100 can have one rear wheel 110 and two front wheels 120, or two rear wheels 110 and one front wheel 120. A first laser sensor 20 and a second laser sensor 30 for measuring different distances can be mounted in the center of the frame on the side of the rear wheels 110 of the mobility device 100. Here, although a laser sensor is described as an example for a distance sensor, the distance sensor can be implemented with various sensors such as an ultrasonic sensor.

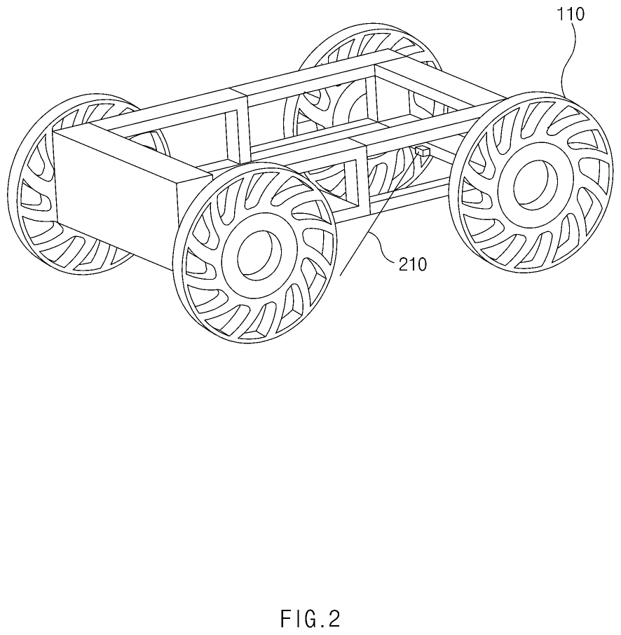

FIG. 2 is a view showing an example of an irradiation direction of a first laser sensor mounted on a mobility device.

Referring to FIG. 2, the first laser sensor 20 mounted on the mobility device 100 can be mounted to have a first irradiation angle with respect to the front of the mobility device 100. For example, an irradiation direction 210 of the first laser sensor 20 can be directed to face the front of the mobility device 100 with respect to the vertical direction from the mobility device 100 to the ground.

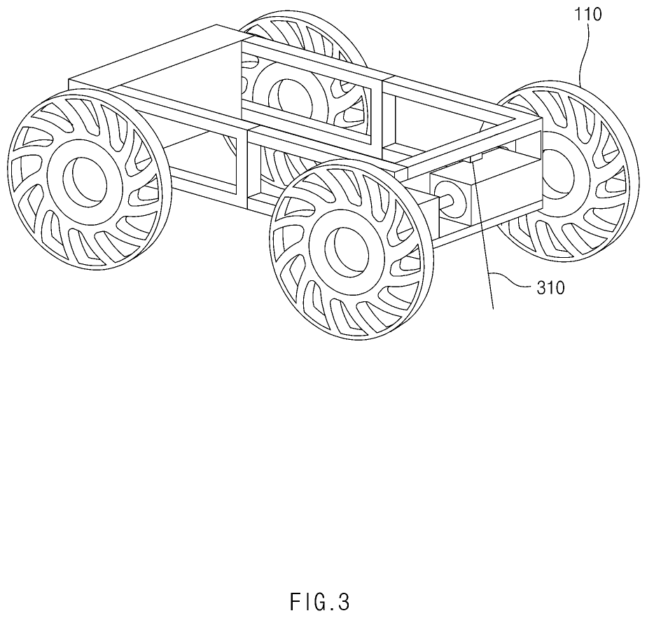

FIG. 3 is a view showing an example of an irradiation direction of a second laser sensor mounted on a mobility device.

Referring to FIG. 3, the second laser sensor 30 mounted on the mobility device 100 can be mounted to have a second irradiation angle with respect to the rear of the mobility device 100. For example, an irradiation direction 310 of the second laser sensor 30 can be directed to face the rear of the mobility device 100 with respect to the vertical direction from the mobility device 100 to the ground.

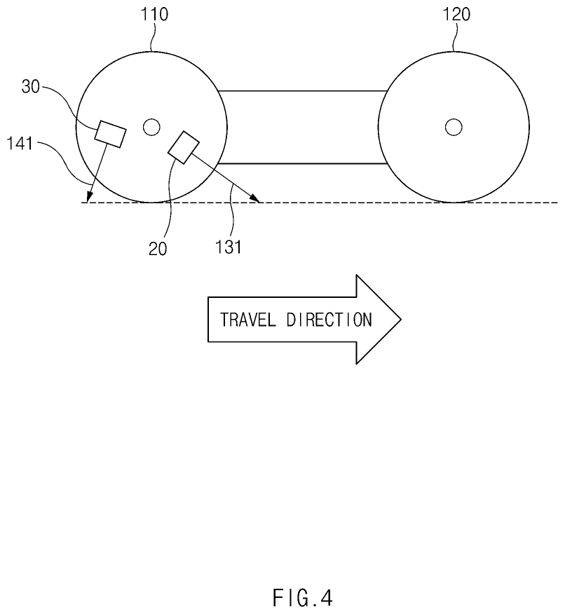

FIG. 4 is a view showing a mobility device traveling on a flat ground.

Referring to FIG. 4, the mobility device 100 can maintain the level on the flat ground, and the first laser sensor 20 fixed to a frame (vehicle body) on the side of the rear wheel 110 of the mobility device 100 can measure a distance “a” from a road surface when moving forward on the flat ground, and the second laser sensor 30 fixed to the frame on the side of the rear wheel 110 of the mobility device 100 can measure a distance “b” from a road surface when moving backward on the flat ground. In this case, the irradiation angle of the first laser sensor 20 and the irradiation angle of the second laser sensor 30 can be different from each other, and therefore, the measured distances can be also different from each other.

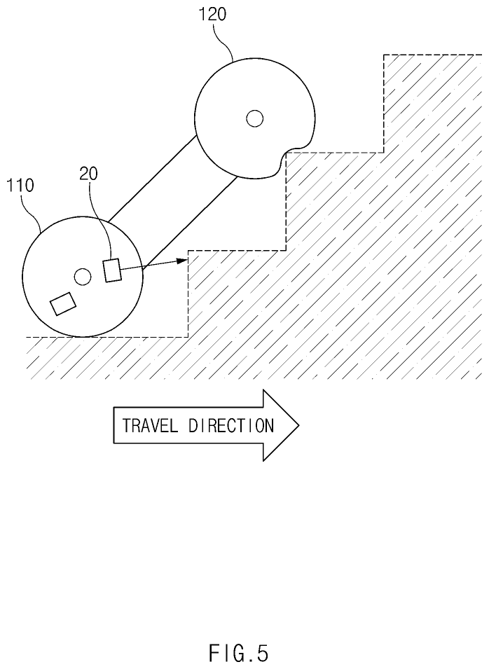

FIG. 5 is a diagram for describing that a mobility device is traveling on uphill stairs.

Referring to FIG. 5, when the mobility device 100 is traveling on uphill stairs, a distance to the stairs measured by the first laser sensor 20 can be shorter or longer than the distance “a” on the flat ground.

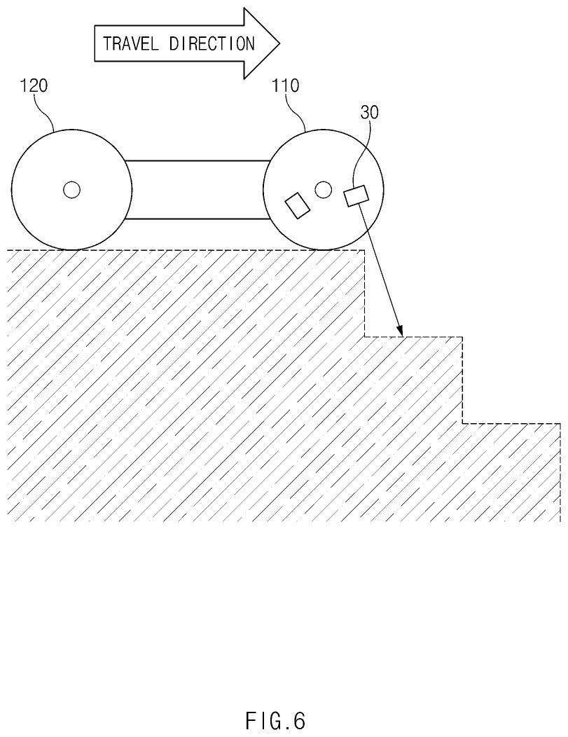

FIG. 6 is a diagram for describing that a mobility device is traveling on downhill stairs.

Referring to FIG. 6, when the mobility device 100 is traveling on downhill stairs, a distance to the stairs measured by the second laser sensor 30 can be shorter or longer than the distance “b” on the flat ground. In this case, when the distance to the stairs measured by the second laser sensor 30 is longer than the distance “b” on the flat ground, a controller 40 or 41 can recognize that the stairs are downhill stairs.

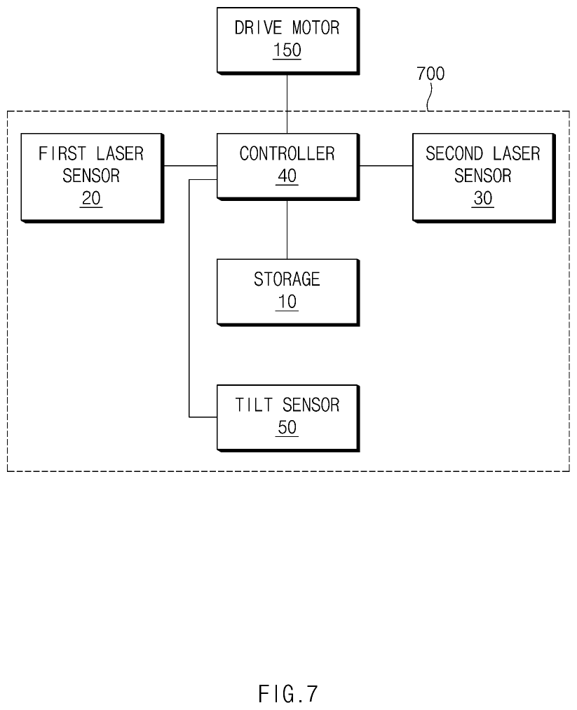

FIG. 7 is a configuration diagram of a travel control device for a mobility device.

Referring to FIG. 7, a travel control device 700 for a mobility device can include storage 10, the first laser sensor 20, the second laser sensor 30, the controller 40, and a tilt sensor 50. In this case, according to a method for embodying the travel control device 700 for a mobility device, components can be combined with each other as one entity, or some components can be omitted.

The above components will be described below. First, the storage 10 can store various logics, algorithms, and programs required in a process of adjusting a travel speed of the mobility device 100 based on a distance to stairs measured by a distance sensor when traveling on the stairs in a state in which the distance sensor has been provided in one side (e.g., rear wheel side) frame of the mobility device 100.

In particular, the storage 10 can store various logics, algorithms, and programs required in a process of adjusting a travel speed of the mobility device 100 based on a distance to stairs measured by a forward distance sensor or a distance to the stairs measured by a reverse distance sensor when traveling on the stairs in a state in which the forward distance sensor (e.g., the first laser sensor 20) and the reverse distance sensor (e.g., the second laser sensor 30) have been provided in one side frame of the mobility device 100.

The storage 10 can include at least one type of storage medium of memories such as a flash memory type memory, a hard disk type memory, a micro type memory, and a card type memory (e.g., an SD card (Secure Digital Card) or an XD card (eXtream Digital Card)), a RAM (Random Access Memory), an SRAM (Static RAM), a ROM (Read Only Memory), a PROM (Programmable ROM), a EEPROM (Electrically Erasable PROM), a MRAM (Magnetic RAM), and an optical disk type memory.

The first laser sensor 20 can be activated to measure a distance to a road surface, a distance to an obstacle, a distance to stairs, and the like, when the mobility device 100 moves forward.

The second laser sensor 30 can be activated to measure a distance to a road surface, a distance to an obstacle, a distance to stairs, and the like, when the mobility device 100 moves backward.

The controller 40 can perform overall control such that each of the above components normally performs its function. The controller 40 can be implemented in the form of hardware or software, or can be implemented in a combination of hardware and software. For example, the controller 40 can be implemented with a microprocessor, but is not limited thereto.

In particular, the controller 40 can be equipped with a distance sensor in one side (e.g., rear wheel side) frame of the mobility device 100 and perform a variety of control in a process of adjusting a travel speed of the mobility device 100 based on a distance to stairs measured by a distance sensor when traveling on the stairs.

That is, the controller 40 can be equipped with a forward distance sensor (e.g., the first laser sensor 20) and a reverse distance sensor (e.g., the second laser sensor 30) in one side frame of the mobility device 100 and perform a variety of control in a process of adjusting a travel speed of the mobility device 100 based on a distance to stairs measured by the forward distance sensor when traveling on the stairs and a distance to stairs measured by the reverse distance sensor when traveling on the stairs. In this case, the controller 40 can control a drive motor 150 to adjust the travel speed of the mobility device 100.

In addition, the controller 40 can activate the first laser sensor 20 when the mobility device 100 travels forward on the stairs, and activate the second laser sensor 30 when the mobility device 100 travels backward on the stairs.

In addition, the controller 40 can additionally identify a stair traveling state of the mobility device 100 by using the tilt sensor 50. That is, the controller 40 can identify the stair traveling state of the mobility device 100 when a tilt measured by the tilt sensor 50 exceeds a threshold angle.

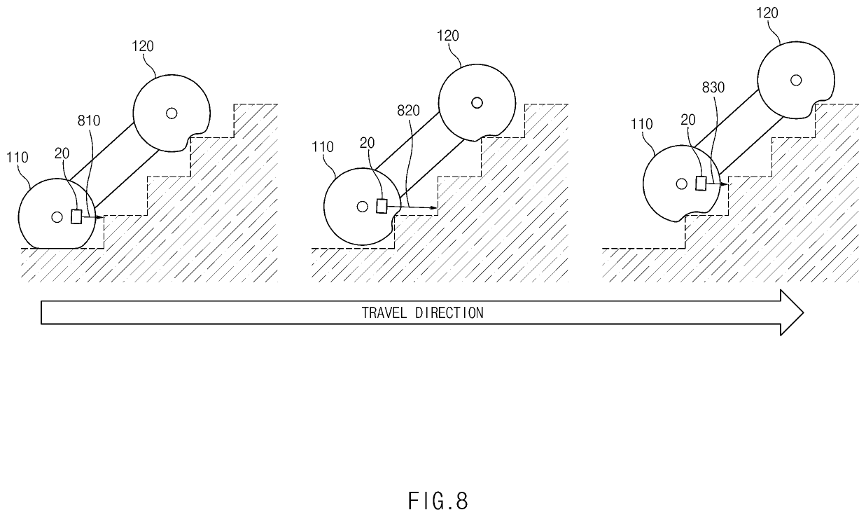

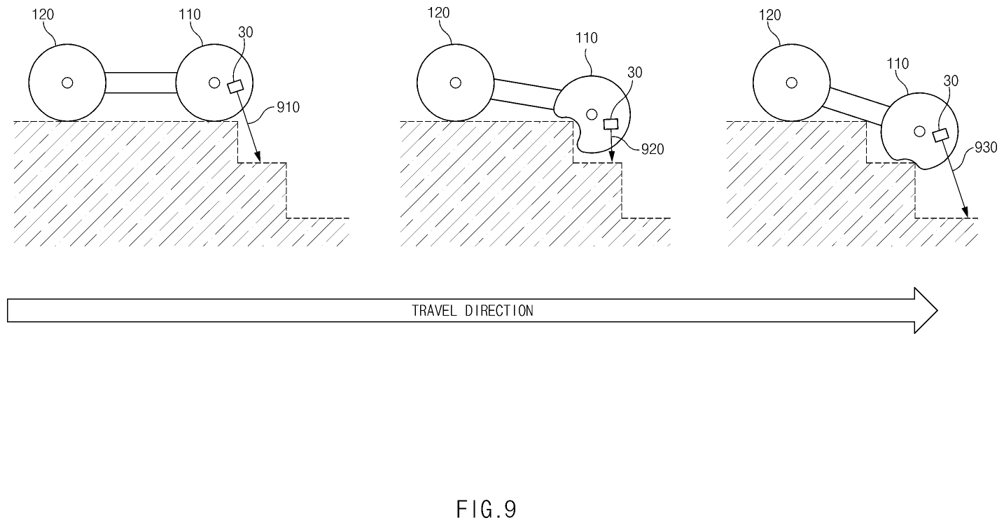

Hereinafter, a process of controlling a travel speed of the mobility device 100 by the controller 40 will be described in detail with reference to FIGS. 8 and 9.

FIG. 8 is a view illustrating a process in which a controller provided in a travel control device for a mobility device adjusts a travel speed of the mobility device when traveling on uphill stairs.

First, the controller 40 can activate the first laser sensor 20 as the mobility device 100 travels forward on stairs.

Thereafter, it can be seen from FIG. 8 that a distance 810 from the stairs measured by the first laser sensor 20 is shorter than a preset distance “a” as one side frame of the mobility device 100 approaches the stairs.

When the distance 810 measured by the first laser sensor 20 is shorter than the preset distance “a”, the controller 40 can reduce the travel speed of the mobility device 100. For example, the controller 40 can reduce the travel speed of the mobility device 100 by 70%. That is, when the travel speed of the mobility device 100 is 100 RPM (Revolutions Per Minute), the travel speed can be reduced to 30 RPM.

Thereafter, when the distance 820 measured by the first laser sensor 20 exceeds the preset distance “a”, the controller 40 can increase the travel speed of the mobility device 100 back to the previous speed. For example, when the travel speed of the mobility device 100 has been reduced from 100 RPM to 30 RPM, the controller 40 can increase the travel speed back to 100 RPM.

Thereafter, when the distance 830 measured by the first laser sensor 20 is shorter than the preset distance “a”, the controller 40 can again reduce the travel speed of the mobility device 100. For example, when the travel speed of the mobility device 100 is 100 RPM, the controller 40 can reduce the travel speed to 30 RPM.

FIG. 9 is a view illustrating a process in which a controller provided in a travel control device for a mobility device adjusts a travel speed of the mobility device when traveling on downhill stairs.

First, the controller 40 can activate the second laser sensor 30 as the mobility device 100 travels in reverse on stairs.

Thereafter, it can be seen from FIG. 9 that a distance 910 from the stairs measured by the second laser sensor 30 is longer than a predetermined distance “b” as one side frame of the mobility device 100 approaches the stairs.

When the distance 910 measured by the second laser sensor 30 exceeds the preset distance “b”, the controller 40 can reduce the travel speed of the mobility device 100. For example, the controller 40 can reduce the travel speed of the mobility device 100 by 70%. That is, when the travel speed of the mobility device 100 is 100 RPM (Revolutions Per Minute), the travel speed can be reduced to 30 RPM.

Thereafter, when the distance 920 measured by the second laser sensor 30 is shorter than the preset distance “b”, the controller 40 can increase the travel speed of the mobility device 100 back to the previous speed. For example, when the travel speed of the mobility device 100 has been reduced from 100 RPM to 30 RPM, the controller 40 can increase the travel speed back to 100 RPM.

Thereafter, when the distance 930 measured by the second laser sensor 30 again exceeds the preset distance “b”, the controller 40 can again reduce the travel speed of the mobility device 100. For example, when the travel speed of the mobility device 100 is 100 RPM, the controller 40 can reduce the travel speed to 30 RPM.

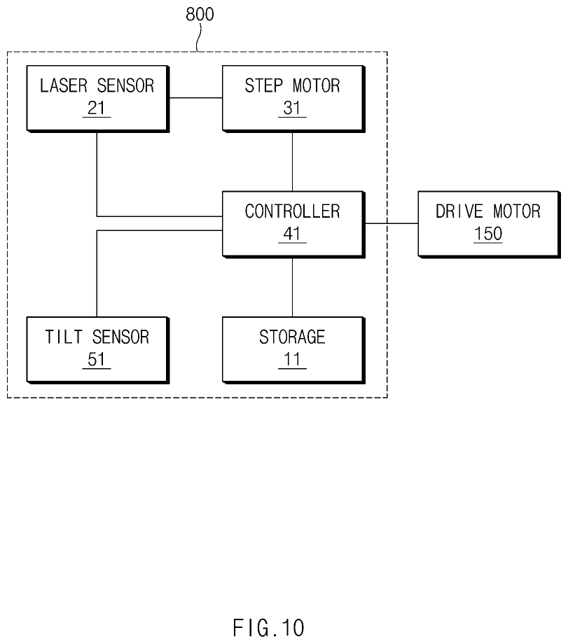

FIG. 10 is a configuration diagram of a travel control device for a mobility device.

Referring to FIG. 10, a travel control device 800 for a mobility device can include storage 11, a laser sensor 21, a step motor 31, a controller 41, and a tilt sensor 51. In this case, according to a method for embodying the travel control device 800 for a mobility device, components can be combined with each other as one entity, or some components can be omitted. In addition, the description has been given by taking the step motor 31 as an example, but, in some implementations, the travel control device 800 can be implemented with any one of a DC motor with an encoder, a brushless DC (BLDC) motor, and a servo motor with an encoder function.

The above components will be described below. First, the storage 11 can store various logics, algorithms, and programs required in a process of adjusting a travel speed of the mobility device 100 based on a distance to stairs measured by a distance sensor when driving on the stairs in a state in which the distance sensor has been provided in one side frame of the mobility device 100.

Specifically, the storage 11 can store various logics, algorithms, and programs required in a process of controlling a distance sensor to have a first irradiation angle and adjusting the travel speed of the mobility device 100 based on a distance to stairs measured by the distance sensor having the first irradiation angle when traveling forward on the stairs and controlling a distance sensor to have a second irradiation angle and adjusting the travel speed of the mobility device 100 based on a distance to stairs measured by the distance sensor having the second irradiation angle when traveling backward on the stairs in a state in which a distance sensor (e.g., the laser sensor 21), of which an irradiation angle is changed by the step motor 31, has been provided in one side frame of the mobility device 100. In this case, the controller 41 can control the drive motor 150 to adjust the travel speed of the mobility device 100.

The storage 11 can include at least one type of storage medium of memories such as a flash memory type memory, a hard disk type memory, a micro type memory, and a card type memory (e.g., an SD card (Secure Digital Card) or an XD card (eXtream Digital Card)), a RAM (Random Access Memory), an SRAM (Static RAM), a ROM (Read Only Memory), a PROM (Programmable ROM), a EEPROM (Electrically Erasable PROM), a MRAM (Magnetic RAM), and an optical disk type memory.

The laser sensor 21 is a sensor whose irradiation direction (irradiation angle) is controlled by the step motor 31 and can measure a distance to stairs.

The step motor 31 can adjust the irradiation direction of the laser sensor 21 under the control of the controller 41.

The controller 41 can perform overall control such that each of the above components normally performs its function. The controller 41 can be implemented in the form of hardware or software, or can be implemented in a combination of hardware and software. For example, the controller 41 can be implemented with a microprocessor, but is not limited thereto.

In particular, the controller 41 can be equipped with a distance sensor in one side frame of the mobility device 100 and perform a variety of control in a process of adjusting a travel speed of the mobility device 100 based on a distance to stairs measured by a distance sensor when driving on the stairs.

That is, the controller 41 can perform a variety of control in the process of controlling a distance sensor to have a first irradiation angle and adjusting the travel speed of the mobility device 100 based on a distance to stairs measured by the distance sensor having the first irradiation angle when traveling forward on the stairs and controlling a distance sensor to have a second irradiation angle and adjusting the travel speed of the mobility device 100 based on a distance to stairs measured by the distance sensor having the second irradiation angle when traveling backward on the stairs in a state in which the distance sensor (e.g., the laser sensor 21), of which an irradiation angle is changed by the step motor 31, has been provided in one side frame of the mobility device 100.

In addition, the controller 41 can activate the laser sensor 21 when the mobility device 100 travels forward or in reverse on the stairs.

In addition, the controller 41 can control the step motor 31 such that the laser sensor 21 has a first irradiation angle when the mobility device 100 travels forward on the stairs, and control the step motor 31 such that the laser sensor 21 has a second irradiation angle when the mobility device 100 travels in reverse on the stairs.

In addition, the controller 41 can additionally identify a stair traveling state of the mobility device 100 by using the tilt sensor 51. That is, the controller 41 can identify a stair traveling state of the mobility device 100 when the tilt measured by the tilt sensor 51 exceeds a threshold angle.

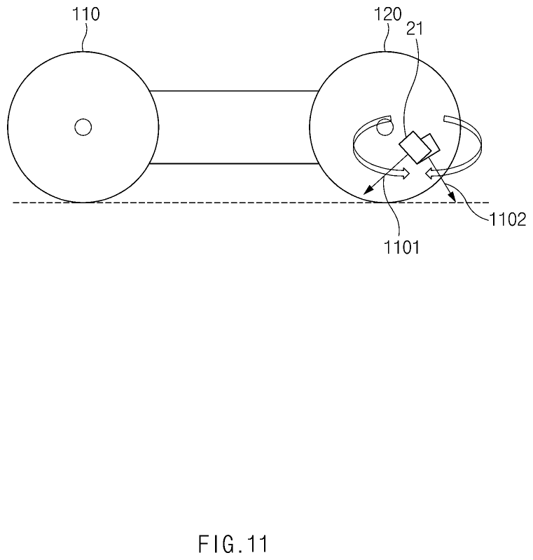

FIG. 11 is a view illustrating an example of an irradiation angle of a laser sensor provided in a travel control device for a mobility device.

Referring to FIG. 11, the controller 41 can control the step motor 31 to adjust the irradiation direction of the laser sensor 21. In addition, the controller 41 can control the step motor 31 such that the irradiation direction of the laser sensor 21 is a first direction 1101 when the mobility device 100 travels forward on the stairs, and control the step motor 31 such that the irradiation direction of the laser sensor 21 is a second direction 1102 when the mobility device 100 travels in reverse on the stairs. For example, the first direction 1101 can be the same as the irradiation direction 210 of the first laser sensor 20, and the second direction 1102 can be the same as the irradiation direction 310 of the second laser sensor 30.

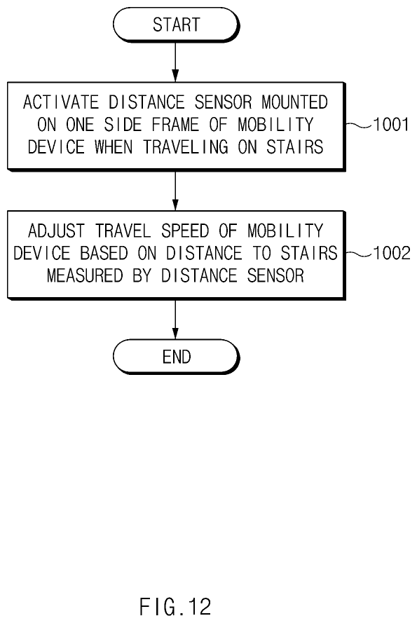

FIG. 12 is a flowchart of a travel control method for a mobility device.

First, the controller 40 can activate a distance sensor mounted on one side frame of the mobility device 100 when traveling on stairs (1001).

Thereafter, the controller 40 can adjust a travel speed of the mobility device 100 based on a distance to the stairs measured by the distance sensor (1002). In this case, a process of adjusting the travel speed of the mobility device 100 can be implemented by various methods.

For example, in some implementations, when the first laser sensor 20 and the second laser sensor 30 are provided on one side frame of the mobility device 100, the controller 40 can control the travel speed of the mobility device 100 based on a distance to the stairs measured by the first laser sensor 20 when the mobility device 100 travels forward on the stairs and control the travel speed of the mobility device 100 based on a distance to the stairs measured by the second laser sensor 30 when the mobility device 100 travels in reverse on the stairs.

In some implementations, when the laser sensor 21 of which the irradiation angle is changed by the step motor is provided on one side frame of the mobility device 100, the controller 41 can control the laser sensor 21 to have a first irradiation angle and adjust the travel speed of the mobility device 100 based on a distance to the stairs measured by the laser sensor 21 when the mobility device 100 travels forward on the stairs, and control the laser sensor 21 to have a second irradiation angle and adjust the travel speed of the mobility device 100 based on a distance to the stairs measured by the laser sensor 21 when the mobility device 100 travels in reverse on the stairs.

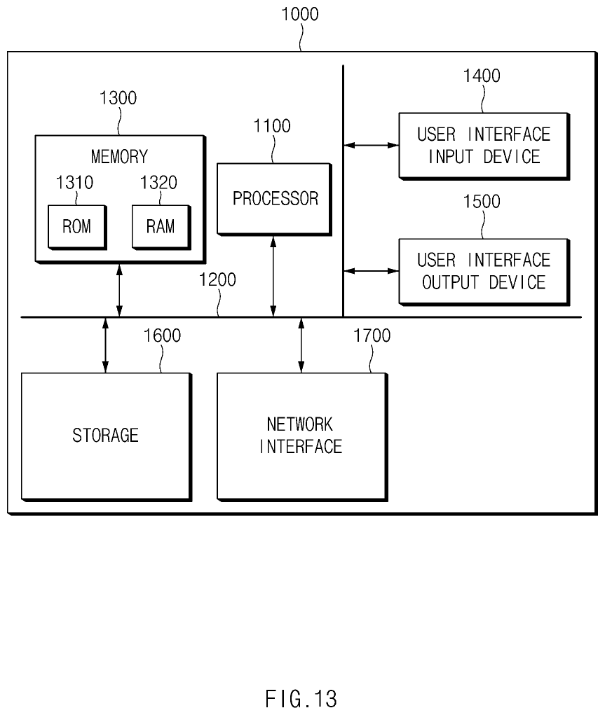

FIG. 13 is a block diagram illustrating a computing system for performing a method for controlling a travel control method for a mobility device.

Referring to FIG. 13, a method for controlling the travel control method for a mobility device as described above can be also implemented through a computing system. A computing system 1000 can include at least one processor 1100, a memory 1300, a user interface input device 1400, a user interface output device 1500, storage 1600, and a network interface 1700, which are connected with each other via a system bus 1200.

The processor 1100 can be a central processing unit (CPU) or a semiconductor device that processes instructions stored in the memory 1300 and/or the storage 1600. The memory 1300 and the storage 1600 can include various types of volatile or non-volatile storage media. For example, the memory 1300 can include a ROM (Read Only Memory) 1310 and a RAM (Random Access Memory) 1320.

Thus, the operations of the method or the algorithm described herein can be embodied directly in hardware or a software module executed by the processor 1100, or in a combination thereof. The software module can reside on a storage medium (that is, the memory 1300 and/or the storage 1600) such as a RAM, a flash memory, a ROM, an EPROM, an EEPROM, a register, a hard disk, a solid state drive (SSD) a removable disk, and a CD-ROM. The exemplary storage medium can be coupled to the processor 1100, and the processor 1100 can read information out of the storage medium and can record information in the storage medium. Alternatively, the storage medium can be integrated with the processor 1100. The processor 1100 and the storage medium can reside in an application specific integrated circuit (ASIC). The ASIC can reside within a user terminal. In another case, the processor and the storage medium can reside in the user terminal as separate components.

The above description is merely illustrative of the technical idea of the present disclosure, and various modifications and variations can be made without departing from the essential characteristics of the present disclosure by those skilled in the art to which the present disclosure pertains.

Therefore, the exemplary implementations of the present disclosure are provided to explain the spirit and scope of the present disclosure, but not to limit them, so that the spirit and scope of the present disclosure is not limited by the implementations. The scope of protection of the present disclosure should be interpreted by the following claims, and all technical ideas within the scope equivalent thereto should be construed as being included in the scope of the present disclosure.

The travel control device includes a distance sensor on one side frame of the mobility device and adjusts a travel speed of the mobility device based on a distance to stairs measured by the distance sensor when the mobility device travels on the stairs to reduce collision force between the mobility device and the stairs, thereby improving the traveling stability and immediacy of the mobility device.

Hereinabove, although the present disclosure has been described with reference to exemplary implementations and the accompanying drawings, the present disclosure is not limited thereto, but can be variously modified and altered by those skilled in the art to which the present disclosure pertains without departing from the spirit and scope of the present disclosure claimed in the following claims.

What is claimed is:

1. A travel control device configured to control a mobility device, the travel control device comprising:
a distance sensor configured to be disposed at a frame of the mobility device, the distance sensor being configured to, based on the mobility device traveling on stairs, measure a distance from the mobility device to the stairs; and
a controller configured to, while the mobility device travels on the stairs, adjust a travel speed of the mobility device based on the measured distance to the stairs.

2. The travel control device of claim 1, wherein the distance sensor comprises:
a first laser sensor configured to, based on the mobility device traveling on uphill stairs in a first direction, measure a first distance from the mobility device to the uphill stairs; and
a second laser sensor configured to, based on the mobility device traveling on downhill stairs in a second direction opposite to the first direction, measure a second distance from the mobility device to the downhill stairs.

3. The travel control device of claim 2, wherein the controller is configured to activate the first laser sensor based on the mobility device traveling on the uphill stairs in the first direction.

4. The travel control device of claim 2, wherein the controller is configured to activate the second laser sensor based on the mobility device traveling on the downhill stairs in the second direction.

5. The travel control device of claim 2, wherein the controller is configured to reduce the travel speed of the mobility device based on the first distance to the stairs being less than a first threshold distance while the mobility device travels on the uphill stairs in the first direction.

6. The travel control device of claim 2, wherein the controller is configured to reduce the travel speed of the mobility device based on the second distance to the stairs being greater than a threshold distance while the mobility device travels on the downhill stairs in the second direction.

7. The travel control device of claim 1, further comprising:
a tilt sensor configured to measure a tilt of the mobility device with respect to a reference position of the mobility device,
wherein the controller is configured to adjust the travel speed of the mobility device based on the tilt measured by the tilt sensor being greater than a threshold angle.

8. The travel control device of claim 1, wherein the distance sensor comprises:
a laser sensor configured to emit light; and
a motor configured to adjust an irradiation angle of the laser sensor.

9. The travel control device of claim 8, wherein the controller is configured to:
control the motor to adjust the irradiation angle of the laser sensor to a first irradiation angle based on the mobility device traveling on uphill stairs in a first direction; and
control the motor such to adjust the irradiation angle of the laser sensor to a second irradiation angle based on the mobility device traveling on downhill stairs in a second direction opposite to the first direction.

10. The travel control device of claim 8, wherein the controller is configured to reduce the travel speed of the mobility device based on the measured distance to the stairs being less than a first threshold distance while the mobility device travels on uphill stairs.

11. The travel control device of claim 8, wherein the controller is configured to reduce the travel speed of the mobility device based on the measured distance to the stairs being greater than a threshold distance while the mobility device travels on downhill stairs.

12. A travel control method for controlling a mobility device, the travel control method comprising:
activating, by a controller, a distance sensor disposed at a frame of the mobility device based on the mobility device traveling on stairs, the distance sensor being configured to measure a distance from the mobility device to the stairs based on the mobility device traveling on the stairs; and
while the mobility device travels on the stairs, adjusting, by the controller, a travel speed of the mobility device based on the measured distance to the stairs.

13. The travel control method of claim 12, wherein the distance sensor comprises:
a first laser sensor configured to measure a first distance to uphill stairs based on the mobility device traveling on the uphill stairs in a first direction; and
a second laser sensor configured to measure a second distance to downhill stairs based on the mobility device traveling on the downhill stairs in a second direction opposite to the first direction.

14. The travel control method of claim 13, wherein the activating the distance sensor comprises:
activating, by the controller, the first laser sensor based on the mobility device traveling on the uphill stairs in the first direction; and
activating, by the controller, the second laser sensor based on the mobility device traveling on the downhill stairs in the second direction.

15. The travel control method of claim 13, wherein the adjusting the travel speed of the mobility device comprises:
reducing the travel speed of the mobility device based on the first distance to the stairs being less than a first threshold distance while the mobility device travels on the uphill stairs in the first direction; and
reducing the travel speed of the mobility device based on the second distance to the stairs being greater than a second threshold distance while the mobility device travels on the downhill stairs in the second direction.

16. The travel control method of claim 12, wherein the adjusting the travel speed of the mobility device comprises:
measuring, by a tilt sensor, a tilt of the mobility device with respect to a reference position of the mobility device; and
adjusting, by the controller, the travel speed of the mobility device based on the tilt measured by the tilt sensor being greater than a threshold angle.

17. The travel control method of claim 12, wherein the distance sensor comprises:
a laser sensor configured to emit light; and
a motor configured to adjust an irradiation angle of the laser sensor.

18. The travel control method of claim 17, wherein the activating the distance sensor comprises:
controlling the motor to adjust the irradiation angle of the laser sensor to a first irradiation angle based on the mobility device traveling on uphill stairs in a first direction; and
controlling the motor to adjust the irradiation angle of the laser sensor to a second irradiation angle based on the mobility device traveling on downhill stairs in a second direction opposite to the first direction.

19. The travel control method of claim 17, wherein the adjusting the travel speed of the mobility device comprises:
reducing the travel speed of the mobility device based on the measured distance to the stairs being less than a first threshold distance while the mobility device travels on uphill stairs.

20. The travel control method of claim 17, wherein the adjusting the travel speed of the mobility device comprises:
reducing the travel speed of the mobility device based on the measured distance to the stairs being greater than a threshold distance while the mobility device travels on downhill stairs.
